(19) United States
(12) Patent Application Publication
(10) Pub. No.: US 2017/0302693 A1
(43) Pub. Date: Oct. 19, 2017

(54) REWRITE DETECTION SYSTEM AND INFORMATION PROCESSING DEVICE

(71) Applicants: National University Corporation Nagoya University, Nagoya-shi, Aichi (JP); AutoNetworks Technologies, Ltd., Yokkaichi-shi, Mie (JP); Sumitomo Wiring Systems, Ltd., Yokkaichi-shi, Mie (JP); Sumitomo Electric Industries, Ltd., Osaka-shi, Osaka (JP)

(72) Inventors: Hiroaki Takada, Nagoya-shi, Aichi (JP); Hiroki Takakura, Nagoya-shi, Aichi (JP); Naoki Adachi, Yokkaichi-shi, Mie (JP); Yukihiro Miyashita, Yokkaichi-shi, Mie (JP); Satoshi Horihata, Yokkaichi-shi, Mie (JP); Hiroshi Okada, Yokkaichi-shi, Mie (JP)

(21) Appl. No.: 15/514,267

(22) PCT Filed: Sep. 11, 2015
(86) PCT No.: PCT/JP2015/075814

§ 371 Date: Mar. 24, 2017

(30) Foreign Application Priority Data
Sep. 26, 2014 (JP) 2014-196994

(51) Int. Cl. H04L 29/06; G06F 3/06; H04L 29/08

(52) U.S. Cl. CPC H04L 63/1425; G06F 3/067; G06F 3/0623; G06F 3/0659; H04L 67/10

(57) ABSTRACT

Provided are a rewrite detection system and an information processing device capable of reducing communication traffic between devices and processing time in each device. A rewrite detecting device generates a random seed and transmits the random seed to an ECU, the ECU calculates a hash value using a predetermined hash function, and transmits the hash value to a rewrite detecting device. The ECU decides a storage region serving among storage regions of the storage unit, and calculates the hash value. The rewrite detecting device determines whether the hash value received from the ECU is right or wrong, and determines whether or not fraudulent rewrite has been performed. The ECU designates a storage region which is apart from a storage region used as a previous hash value calculation target by a predetermined address as a storage region of a current processing target.

### CROSS-REFERENCE TO RELATED APPLICATIONS

This application is the national phase under 35 U. S. C. §371 of PCT International Application No. PCT/JP2015/075814 which has an International filing date of Sep. 11, 2015, which claims priority of Japanese Patent Application No. 2014-196994 filed Sep. 26, 2014.

### FIELD

The present disclosure relates to a rewrite detection system that detects a fraudulent rewrite of a program or data for an information processing device such as an electronic control unit (ECU) mounted in a vehicle and an information processing device that constitutes the system.

### BACKGROUND

In an information processing device such as an ECU mounted in a vehicle, a processing unit such as a central processing unit (CPU) performs various processes based on programs and data stored in a storage unit such as a read only memory (ROM).

In recent vehicles, a function of revising programs and data stored in the storage unit of the information processing device via an in-vehicle network such as a controller area network (CAN) has been put into practical use. Through such a function, for example, a version upgrade of software of the information processing device can be easily performed, and high functionality of the information processing device can be easily implemented.

Patent Document 1: Japanese Patent Application Laid-Open No. 2013-17140 discloses an in-vehicle network system in which a configuration management device that authenticates an in-vehicle control device is arranged, and the configuration management device delivers configuration verification data used for performing configuration verification to the in-vehicle control device through a registration device connected to an in-vehicle network.

### SUMMARY

Since the programs and data stored in the storage unit of the information processing device can be rewritten, fraudulent program and data rewrite is likely to be performed. For example, when a plurality of unspecified users use a vehicle as in a shared car or a rental car, a malicious user is likely to perform fraudulent rewrite. Further, for example, the user is likely to perform fraudulent alteration on his/her vehicle.

For example, when the information processing device is provided with an advanced authentication function, an advanced encryption function, or the like, fraudulent rewrite of a program or data in the storage unit is considered to be prevented. However, when the information processing device is provided with such functions, there is a problem in that the cost of the information processing device increases. Further, it is not easy to prevent the fraudulent rewrite completely. The in-vehicle network system disclosed in Patent Document 1 has the same problem as well.

In order to solve the problem, the inventors of the present disclosure proposes a system in which seed information is transmitted to an information processing device, the information processing device that has received the seed information calculates a hash value using the seed information and a program or data stored in a storage unit, and fraudulent rewrite is detected according to the hash value calculated by the information processing device is identical to an expected value.

The present disclosure was made in light of the foregoing, and it is an object of the present disclosure to provide a rewrite detection system and an information processing device which are capable of reducing communication traffic between devices and reducing a processing time in each device in the system in which the fraudulent rewrite is detected using the hash value.

A rewrite detection system according to an aspect of the present disclosure is a rewrite detection system that detects rewrite of a program or data stored in a storage unit on an information processing device including the storage unit that stores the program or the data, a processing unit that performs processing based on the program or the data stored in the storage unit, and a communication unit that performs communication with another device via a network, the rewrite detection system comprising a rewrite detecting device that includes a seed information transmitting unit that transmits seed information for hash value calculation to the information processing device via the network, a hash value receiving unit that receives a hash value transmitted from the information processing device in response to the seed information transmitted from the seed information transmitting unit, and a hash value determining unit that determines whether the hash value received through the hash value receiving unit is right or wrong, and detects the rewrite according to a determination result of the hash value determining unit, wherein the information processing device includes a storage region deciding unit that decides a storage region to be used as a processing target in the storage unit and a hash value calculating unit that calculates the hash value based on the seed information transmitted by the seed information transmitting unit and the program or the data stored in the storage region decided by the storage region deciding unit and is configured to transmit the hash value calculated by the hash value calculating unit to the rewrite detecting device.

Moreover, the rewrite detection system according to another aspect of the present disclosure is the rewrite detection system wherein the rewrite detecting device is configured to repeatedly transmit the seed information through the seed information transmitting unit and repeatedly detect the rewrite, and the storage region deciding unit of the information processing device is configured to decide a storage region, which is apart from a storage region used as a processing target of previous hash value calculation by a predetermined address, as a processing target.

Moreover, the rewrite detection system according to another aspect of the present disclosure is the rewrite detection system wherein the rewrite detecting device is configured to repeatedly transmit the seed information through the seed information transmitting unit and repeatedly detect the rewrite, and the storage region deciding unit of the information processing device is configured to alternately decide first and second storage regions obtained by dividing the storage unit into two as the storage region of a processing target.

Moreover, the rewrite detection system according to another aspect of the present disclosure is the rewrite detection system wherein the rewrite detecting device is configured to repeatedly transmit the seed information through the seed information transmitting unit and repeatedly detect the rewrite, and the rewrite detecting device includes an information transmitting unit that transmits storage region designation information designating a storage region serving as a processing target of next hash value calculation to the information processing device after the hash value receiving unit receives the hash value from the information processing device, the information processing device includes a storage region designation information storage processing unit that performs processing of storing the storage region designation information received from the rewrite detecting device, and the storage region deciding unit of the information processing device is configured to decide the storage region based on the storage region designation information stored by the storage region designation information storage processing unit.

Moreover, the rewrite detection system according to another aspect of the present disclosure is the rewrite detection system wherein the rewrite detecting device includes an information transmitting unit that transmits storage region designation information designating initial storage region to be used as a processing target of hash value calculation to the information processing device, and the storage region deciding unit of the information processing device is configured to decide the initial storage region to be used as the processing target based on the storage region designation information received from the rewrite detecting device.

Moreover, the rewrite detection system according to another aspect of the present disclosure is a rewrite detection system that detects rewrite of a program or data stored in a storage unit on an information processing device including the storage unit that stores the program or the data, a processing unit that performs processing based on the program or the data stored in the storage unit, and a communication unit that performs communication with another device via a network, the rewrite detection system comprising a rewrite detecting device that includes a seed information transmitting unit that transmits seed information for a hash value calculation to the information processing device via the network, a hash value receiving unit that receives a hash value transmitted from the information processing device in response to the seed information transmitted from the seed information transmitting unit, a hash value determining unit that determines whether the hash value received through the hash value receiving unit is right or wrong, and an information transmitting unit that transmits storage region designation information designating a storage region serving as a processing target of next hash value calculation to the information processing device after the hash value receiving unit receives the hash value from the information processing device, and detects the rewrite according to a determination result of the hash value determining unit, wherein the information processing device includes a storage region designation information storage processing unit that performs processing of storing the storage region designation information received from the rewrite detecting device and a hash value calculating unit that calculates the hash value based on the seed information transmitted by the seed information transmitting unit and the program or the data stored in the storage region designated in the storage region designation information stored by the storage region designation information storage processing unit, and is configured to transmit the calculated hash value to the rewrite detecting device.

Moreover, an information processing device according to another aspect of the present disclosure is an information processing device, comprising: a storage unit that stores a program or data; a processing unit that performs processing based on the program or the data stored in the storage unit; a communication unit that performs communication with another device via a network; a storage region deciding unit that decides a storage region to be used as a processing target from the storage unit; and a hash value calculating unit that calculates the hash value based on the seed information transmitted from the other device and the program or the data stored in the storage region decided by the storage region deciding unit, wherein the information processing device is configured to transmit the hash value calculated by the hash value calculating unit to the other device.

In an aspect of the present disclosure, the rewrite detecting device generates the seed information and transmits the seed information to the information processing device, and the information processing device calculates the hash value based on the received seed information and the program or data stored in the storage unit and transmits the hash value to the rewrite detecting device. At this time, the information processing device decides the storage region to be used as the hash value calculation processing target among the storage regions of the storage unit by itself, and calculates the hash value. For example, a random value having a predetermined number of bits may be generated and used as the seed information. The rewrite detecting device determines whether the hash value received from the information processing device is right or wrong, and determines whether or not the fraudulent rewrite has been performed on the program or the data. In other words, the rewrite detecting device can determine that the fraudulent rewrite has not been performed when the hash value is right and determine that the fraudulent rewrite has been performed when the hash value is not right.

Thus, it is possible to detect the fraudulent rewrite performed on the program or the data of the information processing device and appropriately take a countermeasure such as an operation stop, a repair, or replacement of the information processing device that has undergone the fraudulent rewrite. The information processing device decides the storage region serving as the processing target by itself, and the rewrite detecting device need not transmit information designating a storage region to the information processing device, and thus the communication traffic between the rewrite detecting device and the information processing device can be reduced. Further, the information processing device receives the seed information and thus can start the hash value calculation processing without waiting for reception of the information designating the storage region, and the processing time can be reduced.

Further, in another aspect of the present disclosure, the information processing device designates the storage region which is apart from the storage region used as the previous hash value calculation target by a predetermined address value as the storage region of the current processing target. In other words, for example, when the previous storage region is set to include an A0-th address to an A1-th address, the information processing device can decide, for example, a region including an (A0+α)-th address to an (A1+α)-th address as the current storage region. The rewrite detecting device also stores the same predetermined address value a and specifies a storage region which is a calculation target for which the hash value is calculated by the information processing device. Thus, the information processing device can decide the storage region serving as the processing target easily and reliably.

Further, in another aspect of the present disclosure, the information processing device divides the storage region into two, for example, designates first and second half portions as first and second storage regions, and alternately switches the hash value calculation processing target between the first and second storage regions. Thus, the information processing device can decide the storage region to be used as the processing target easily and reliably.

Further, in another aspect of the present disclosure, after receiving the hash value from the information processing device, the rewrite detecting device transmits the information designating the storage region serving as the next hash value calculation processing target to the information processing device. The information processing device receives the storage region designation information from the rewrite detecting device and stores the storage region designation information, and use the storage region designated in the stored information as the processing target when the next hash value calculation is performed. In this configuration, it is necessary to transmit the information designating the storage region from the rewrite detecting device to the information processing device each time, but the information can be transmitted at an arbitrary timing before the next detection processing is performed, and thus the information can be transmitted, for example, at a timing at which the network load is small. Further, when the seed information is received from the rewrite detecting device, the information processing device can detect the storage region based on the stored information and calculate the hash value without waiting for the reception of the information designating the storage region, and thus the processing time can be reduced.

Further, in another aspect of the present disclosure, in the initial process of the detection processing that is repeatedly performed, the rewrite detecting device transmits information designating a initial storage region to be used as a processing target to the information processing device. When the information designating the storage region is received from the rewrite detecting device, the information processing device calculates the hash value using the designated storage region as the processing target, and otherwise, the information processing device calculates the hash value using the above-described method. Thus, the information processing device can calculate the hash value reliably in the initial process of the detection processing which is repeated.

Further, the rewrite detecting device may be configured to calculate the hash value using a predetermined storage region such as a head region of the storage unit as the initial storage region without designating the initial storage region.

According to an aspect of the present disclosure, the information processing device is configured to decide the storage region to be used as the hash value calculation processing target, and thus it is possible to reduce communication traffic between the rewrite detecting device and the information processing device or reduce a processing time in each device which is required in the rewrite detection processing.

The above and further objects and features will more fully be apparent from the following detailed description with accompanying drawings.

### BRIEF DESCRIPTION OF THE DRAWINGS

FIG. 1 is a schematic diagram illustrating a configuration of a rewrite detection system according to the present embodiment.

FIG. 2 is a block diagram illustrating a configuration of an ECU.

FIG. 3 is a schematic diagram illustrating a configuration of a storage unit of an ECU.

FIG. 4 is a block diagram illustrating a configuration of a rewrite detecting device.

FIG. 5 is a block diagram illustrating a configuration of a server device.

FIG. 6 is a schematic diagram illustrating a first exemplary configuration of a rewrite detection database.

FIG. 7 is a schematic diagram illustrating a second exemplary configuration of a rewrite detection database.

FIG. 8 is a schematic diagram for describing a rewrite detection processing performed by a rewrite detecting device.

FIG. 9 is a schematic diagram for describing a storage region decision method of an ECU according to a first embodiment.

FIG. 10 is a flowchart illustrating a procedure of a rewrite detection processing performed by a rewrite detecting device.

FIG. 11 is a flowchart illustrating a procedure of a rewrite detection processing performed by an ECU.

FIG. 12 is a flowchart illustrating a procedure of a rewrite detection processing performed by a server device.

FIG. 13 is a schematic diagram for describing a storage region decision method of an ECU according to a second embodiment.

FIG. 14 is a schematic diagram for describing a storage region decision method performed by a rewrite detection system according to a third embodiment.

FIG. 15 is a flowchart illustrating a procedure of a rewrite detection processing performed by a rewrite detecting device according to the third embodiment.

FIG. 16 is a flowchart illustrating a procedure of a rewrite detection processing performed by an ECU according to the third embodiment.

### DETAILED DESCRIPTION

### First Embodiment

<System Configuration>

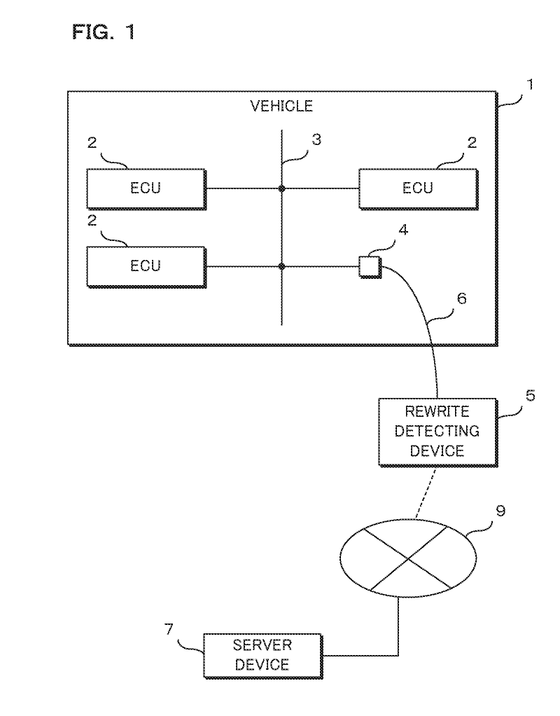

Hereinafter, an aspect of the present disclosure will be specifically described with reference to the appended drawings exemplary embodiments thereof. FIG. 1 is a schematic diagram illustrating a configuration of a rewrite detection system according to the present embodiment. In FIG. 1, 1 indicates a vehicle, and various ECUs 2 such as a body ECU, an engine ECU, or the like are mounted in the vehicle 1. A plurality of ECUs 2 mounted in the vehicle 1 are connected via an in-vehicle network 3 such as a CAN and can perform transmission and reception of information. A connector 4 for connecting the in-vehicle network 3 to other devices is installed in the vehicle 1.

The rewrite detection system according to the present embodiment includes a rewrite detecting device 5 that detects that a fraudulent rewrite has been performed on a program or data of the ECU 2 mounted in the vehicle 1. The rewrite detecting device 5 is a portable device and is stored in, for example, a dealer, a repair shop, or the like of the vehicle 1. The rewrite detecting device 5 is connected to the connector 4 installed in the vehicle 1 via a communication cable 6 and able to perform communication with the ECU 2. The rewrite detecting device 5 performs fraudulent rewrite detection processing on the program or the data of the ECU 2 in a state in which the communication cable 6 is connected to the connector 4.

The rewrite detecting device 5 has a function of performing wireless communication using a wireless local area network (LAN), a mobile telephone network, or the like. In the present embodiment, the rewrite detecting device 5 performs communication with a server device 7 via a network 9 such as the Internet using a wireless communication function. The server device 7 is, for example, a device which is managed and run by a company that manufactures or sells the vehicle 1. The server device 7 stores information which is necessary for the rewrite detection process performed by the rewrite detecting device 5, and transmits the necessary information to the rewrite detecting device 5 according to a request which is transmitted from the rewrite detecting device 5 when the rewrite detection process is performed.

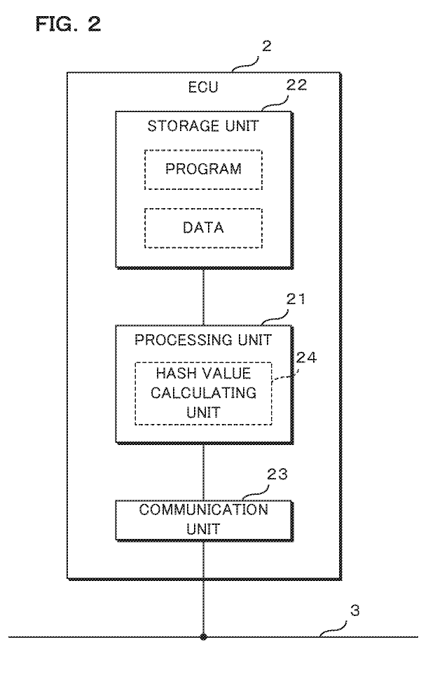

FIG. 2 is a block diagram illustrating a configuration of the ECU 2. The ECU 2 is configured to include a processing unit 21, a storage unit 22, a communication unit 23, and the like. The processing unit 21 is configured with an arithmetic processing device such as a central processing unit (CPU). The processing unit 21 performs various information processing related to the vehicle 1 by reading and executing a program stored in the storage unit 22.

The storage unit 22 is configured with a data writable non-volatile memory device such as a flash memory or an electrically erasable programmable read only memory (EEPROM). The storage unit 22 stores a program executed by the processing unit 21 and various data necessary for processing performed through the program. In the present embodiment, the storage unit 22 is used as a ROM, and the program or data stored in the storage unit 22 is assumed not to be rewritten through the processing of the processing unit 21. Here, it is possible to rewrite the program through a version upgrade.

For example, the communication unit 23 performs communication with other ECUs 2 via the in-vehicle network 3 according to, for example, a communication protocol such as a CAN. The communication unit 23 transmits information to another ECU 2 by converting transmission information transferred from the processing unit 21 into a transmission signal according to a communication protocol and outputting the converted signal to a communication line that constitutes the in-vehicle network 3. The communication unit 23 acquires a signal output from another ECU 2 by sampling an electric potential of the communication line of the in-vehicle network 3, receives information by converting the signal into binary information according to a communication protocol, and transfers the received information to the processing unit 21.

In the present embodiment, the processing unit 21 of the ECU 2 includes a hash value calculating unit 24 that calculates a hash value according to an instruction given from the rewrite detecting device 5. The hash value calculating unit 24 calculates a hash value based on a random seed (seed information) given from the rewrite detecting device 5 and the program or data stored in the storage unit 22 using a predetermined hash calculation algorithm (a hash function). The hash value calculating unit 24 may be implemented as software or may be implemented as hardware. A method of calculating the hash value will be described in detail.

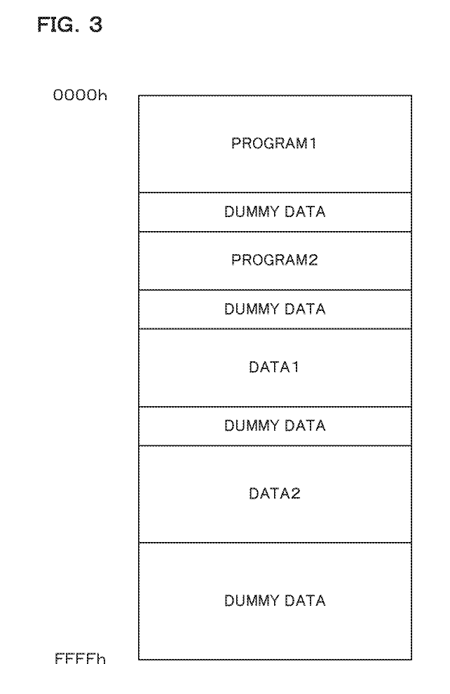

FIG. 3 is a schematic diagram illustrating a configuration of the storage unit 22 of the ECU 2. In an example illustrated in FIG. 3, the storage unit 22 includes storage regions whose address are indicated by 0000h to FFFFh. Two programs (a program 1 and a program 2) executed by the processing unit 21 and two types of data (data 1 and data 2) necessary for execution of the programs are stored in the storage unit 22. The program 1, the program 2, the data 1, and the data 2 are stored in the storage unit 22 in order from an address at the head side, but dummy data is stored in a storage region therebetween and a storage region of an address at the tail end side.

The dummy data may have any value, but for example, a value which is randomly decided may be stored. The dummy data is written in all redundant regions of the storage unit 22. In other words, some sort of data is stored in all storage regions of the storage unit 22. Thus, it is possible to prevent fraudulent processing which is performed by storing a fraudulent program in the redundant region of the storage unit 22. Further, it is possible to make it difficult to compress the program and data stored in the storage unit 22.

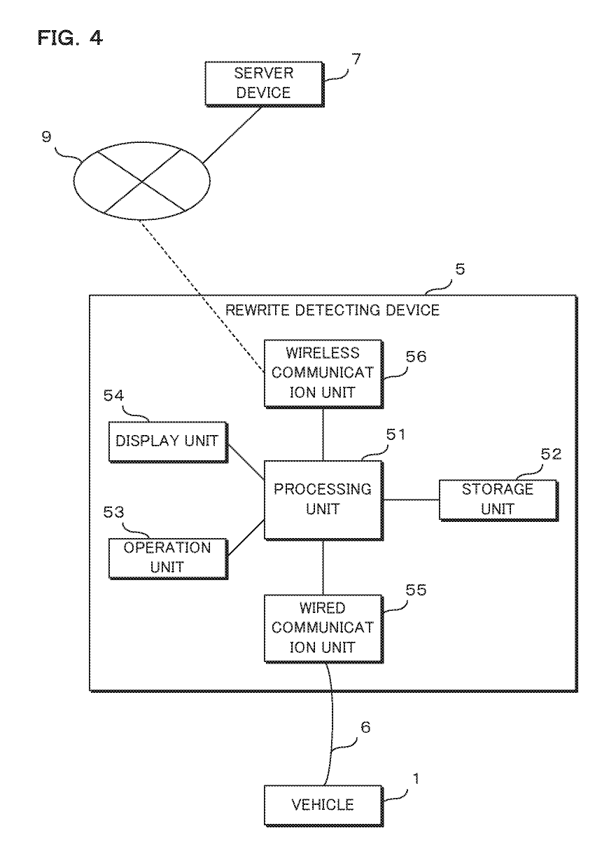

FIG. 4 is a block diagram illustrating a configuration of the rewrite detecting device 5. The rewrite detecting device 5 is configured to include a processing unit 51, a storage unit 52, an operation unit 53, a display unit 54, a wired communication unit 55, the wireless communication unit 56, and the like. The processing unit 51 is configured using an arithmetic processing device such as a CPU. The processing unit 51 performs the fraudulent rewrite detection processing on the program or the data of the ECU 2 mounted in the vehicle 1 by reading and executing the program stored in the storage unit 52. The storage unit 52 is configured with a non-volatile memory device such as a flash memory and stores the program executed by the processing unit 51 and various data necessary for execution of the program. The rewrite detecting device 5 may store temporary information generated in the process of the processing unit 51 in the storage unit 52 and may include a random access memory (RAM) that stores the temporary information.

The operation unit 53 is configured using a push switch, a touch panel, or the like and receives an operation of the user and notifies the processing unit 51 of the operation of the user. The display unit 54 is configured using a liquid crystal (LC) panel and displays various images and messages for the user according an instruction given from the processing unit 51. The wired communication unit 55 performs communication with another device via the communication cable 6 according to a communication protocol such as a CAN. When the communication cable 6 is connected to the connector 4 of the vehicle 1, the wired communication unit 55 can perform communication with the ECU 2 via the in-vehicle network 3 of the vehicle 1. The wireless communication unit 56 performs communication with the server device 7 via the network 9 such as the Internet by performing wireless communication using the wireless LAN, the mobile telephone network, or the like.

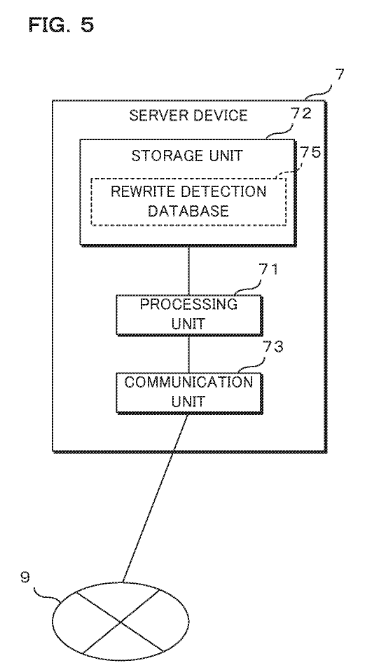

FIG. 5 is a block diagram illustrating a configuration of the server device 7. The server device 7 is configured with a processing unit 71, a storage unit 72, a communication unit 73, and the like. The processing unit 71 is configured using an arithmetic processing device such as a CPU. The processing unit 71 performs processing of transmitting information necessary for the rewrite detection process of the rewrite detecting device 5 by reading and executing a program stored in the storage unit 72. The communication unit 73 performs communication with another device via the network 9 such as the Internet. In the present embodiment, the communication unit 73 performs communication with the rewrite detecting device 5, transfers information received from the rewrite detecting device 5 to the processing unit 71, and transmits transmission information given from the processing unit 71 to the rewrite detecting device 5.

The storage unit 72 is configured using a large-capacity storage device such as a hard disk. In the present embodiment, the storage unit 72 includes a rewrite detection database 75 constructed therein. The rewrite detection database 75 is a database that stores information necessary for the rewrite detection processing of the rewrite detecting device 5. Several configurations are considered to be employed in the rewrite detection database 75, but two exemplary configurations are described below.

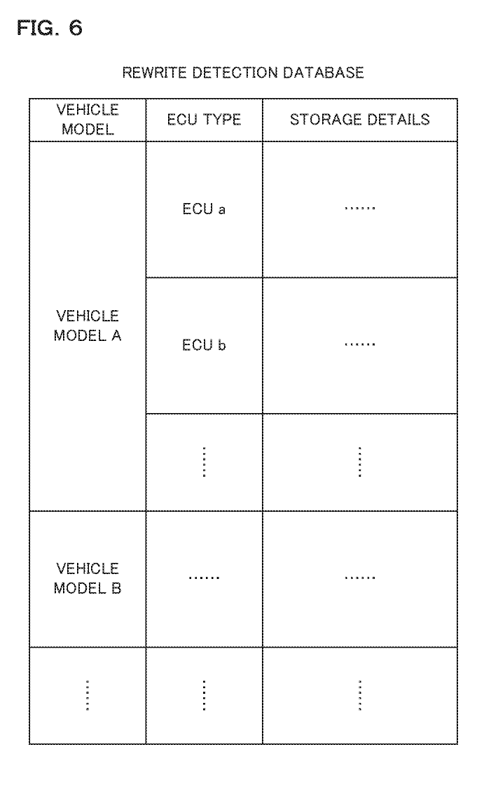

FIG. 6 is a schematic diagram illustrating a first exemplary configuration of the rewrite detection database 75. A “vehicle model,” an “ECU type,” and a “storage details” are stored in the rewrite detection database 75 of the first exemplary configuration in association with one another. For example, identification information identifying a model of the vehicle 1 is stored in the “vehicle model” of the rewrite detection database 75. For example, even when the vehicles 1 are the same in a vehicle name and an external appearance, the vehicles 1 differ in a grade, and when the vehicles 1 differ in a configuration of a mounted ECU 2, the vehicles 2 are dealt as different vehicle models in the present embodiment. In an example illustrated in FIG. 6, information such as a vehicle model A and a vehicle model B are stored in the rewrite detection database 75 as the “vehicle model.” For example, identification information identifying types of the ECUs 2 such as a body ECU and an engine ECU is stored in the “ECU type” of the rewrite detection database 75. In an example illustrated in FIG. 6, information such as an ECU a and an ECU b is stored in the rewrite detection database 75 as the “ECU type.” The “storage details” of the rewrite detection database 75 is a copy of storage details of the storage unit 22 of a corresponding ECU 2.

The rewrite detecting device 5 designates the “vehicle model,” the “ECU type,” the “storage region,” and the “random seed,” and transmits an inquiry about an expected value to the server device 7. The “storage region” related to the inquiry is information for designating some “storage regions” of the storage unit 22 of a corresponding ECU 2, and for example, a storage region is designated by, for example, a combination of a start address X and an end address Y, a combination of the start address X and a region size Z, or the like. The “random seed” related to the inquiry is information which is generated by the rewrite detecting device 5 and is a 4-digit numerical value of a hexadecimal number in the present embodiment.

The server device 7 reads the storage details of the storage region designated by the inquiry from the storage details corresponding to the vehicle model and the ECU type related to the inquiry. The server device 7 calculates a hash value based on the random seed related to the inquiry and the read storage details, and transmits the calculated hash value to the rewrite detecting device 5 as the expected value. To this end, the server device 7 stores the same hash function used by the hash value calculating unit 24 of the ECU 2.

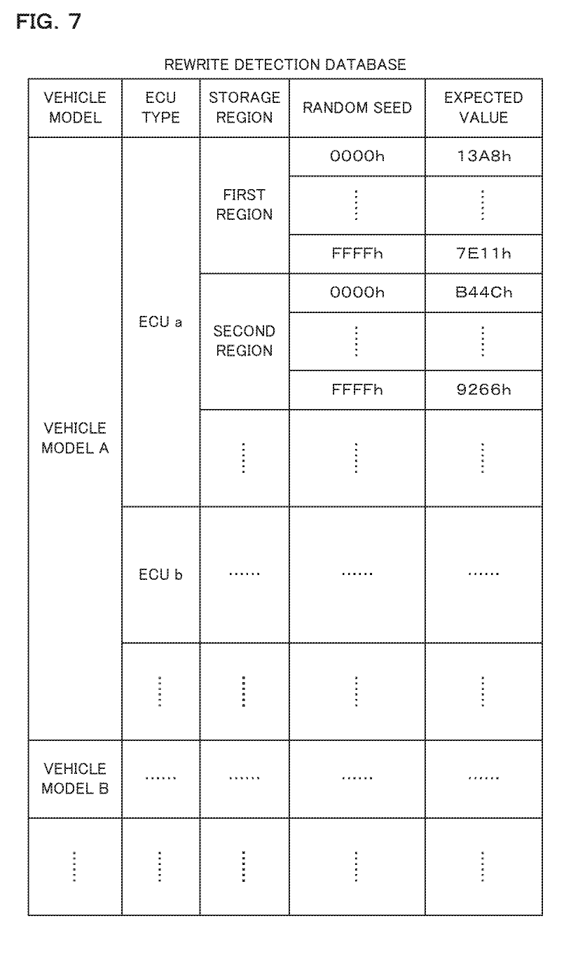

FIG. 7 is a schematic diagram illustrating a second exemplary configuration of the rewrite detection database 75. A “vehicle model,” an “ECU type,” a “storage region,” a “random seed,” and an “expected value” are stored in the rewrite detection database 75 of the second exemplary configuration in association with one another. Among them, the “vehicle model” and the “ECU type” are the same as in the first exemplary configuration. The “storage region” of the rewrite detection database 75 of the second exemplary configuration is information for designating some storage regions of the storage unit 22 of the ECU 2. In an example illustrated in FIG. 7, the storage unit 22 is divided into a plurality of storage regions such as a first region and a second region. The regions may not have the same size and may partially overlap each other.

The “random seed” of the rewrite detection database 75 is a random seed generated by the rewrite detecting device 5 and is a 4-digit numerical value of a hexadecimal number in the present embodiment. In the example illustrated in FIG. 7, 65536 values 0000h to FFFFh are set as the “random seed” for each “ storage region.” The “expected value” of the rewrite detection database 75 is a hash value to be calculated by the ECU 2 for the “storage region” and the “random seed” and is a 4-digit numerical value of a hexadecimal number in the present embodiment. The “expected value” is one in which the hash value is calculated using a corresponding “random seed” and stored for the storage details stored in the “storage region” corresponding to the storage details (a program, data, or dummy data) of the storage unit 22 of the ECU 2. The “expected value” illustrated in FIG. 7 is an example.

The rewrite detecting device 5 designates the “vehicle model,” the “ECU type,” the “storage region,” and the “random seed” and transmits the inquiry about the expected value to the server device 7. The server device 7 reads a corresponding expected value from the rewrite detection database 75 in response to the inquiry, and transmits the read expected value to the rewrite detecting device 5.

In the present embodiment, when the vehicle model and the ECU type are the same, the program and data stored in the storage unit 22 of the ECU 2 are assumed to be the same. However, even when the vehicle model and the ECU type are the same, stored programs and data may differ due to a difference in a destination of the vehicle 1 or a version of a program. In this case, for example, a field such as a version of a program may be set in the rewrite detection database 75, and the storage details of the storage unit 22 may be stored for each version, or the expected value may be stored for each version. The rewrite detecting device 5 acquires the version of the program of the ECU 2 serving as a rewrite detection processing target from the ECU 2, when the inquiry about the expected value is transmitted to the server device 7, version information of the program is transmitted together with information such as the vehicle model and the random seed. The server device 7 can read appropriate information from the rewrite detection database 75 based on the version information of the program transmitted from the rewrite detecting device 5 and transmit the expected value to the rewrite detecting device 5.

<Hash Value Calculation Method>

The hash value calculating unit 24 of the ECU 2 can be configured to calculate the hash value using a known hash function such as a message digest (MD)4, MDS, SHA-1, SHA-256, SHA-384, SHA-512, EIPEMD-160, or SHA-3. These hash functions are one-way hash functions, that is, functions that output one hash value with respect to input information. In the present embodiment, information input to the hash function is all or a part of the programs or data stored in the storage unit 22 of the ECU 2. Regardless of whether either or both of the program and data are input the hash function, the hash function can simply deal input information as binary information and calculate the hash value. The hash value calculating unit 24 stores a determined hash function and calculates the hash value using the hash function.

An example in which the hash value calculating unit 24 calculates the hash value using the hash function of SHA-1 will be briefly described below. A detailed process of the hash function of SHA-1 and an example in which the hash value calculating unit 24 uses other hash functions are known techniques, and thus a description thereof is omitted.

When the hash function of SHA-1 is used, the hash value calculating unit 24 first performs a padding process. In the padding process, the hash value calculating unit 24 adjusts a size of information serving as a processing target to be an integral multiple of a predetermined value (512 bits) by adding excess data behind input information. Then, the hash value calculating unit 24 performs a first process of dividing the information that has undergone the padding process into blocks in units of 512 bits and calculating 80 values for each block.

Then, the hash value calculating unit 24 performs a second process of performing an operation using the values calculated in the first process on an initial value of a predetermined size (160 bits) and using a 160-bit value obtained by the operation as the hash value. In the second process, first, the hash value calculating unit 24 performs an 80-step operation using the 80 values calculated for one block on the 160-bit initial value. Through the 80-step operation, block information can be included in the 160-bit initial value, and thus the 160-bit value is obtained as an output. The hash value calculating unit 24 similarly performs the 80-step operation using the 80 values calculated for a next block using the obtained 160-bit value as the initial value. The hash value calculating unit 24 similarly performs the 80-step process on all blocks, and uses a 160-bit value which is finally obtained as the hash value.

In the present embodiment, it is necessary for the hash value calculating unit 24 to calculate the hash value using the random seed given from the rewrite detecting device 5. For example, the hash value calculating unit 24 may use the random seed as the data which is added to the input information in the padding process. For example, the hash value calculating unit 24 may use the random seed as the 160-bit initial value in the second process. In the present embodiment, the random seed is assumed to be used as the initial value of the second process.

The method of using the random seed through the hash value calculating unit 24 is not limited to the above example. For example, the hash value calculating unit 24 may use a logical operation value (an exclusive OR or the like) of information of the storage unit 22 serving as a hash value calculation target and the random seed as the input information of the hash function. Further, for example, the hash value calculating unit 24 may use information obtained by adding the random seed to a predetermined position, for example, a head portion or a tail end portion of information of the storage unit 22 serving as the hash value calculation target as the input information of the hash function.

<Rewrite Detection Processing>

For example, when the vehicle 1 undergoes a vehicle inspection, a regular inspection, a repair, or the like, a mechanic of a dealer, a repair shop, or the like connects the communication cable 6 of the rewrite detecting device 5 to the connector 4 of the vehicle 1, and connects the rewrite detecting device 5 to the in-vehicle network 3 of the vehicle 1. The mechanic gives an instruction to start the fraudulent rewrite detection processing on the ECU 2 of the vehicle 1 to the rewrite detecting device 5 by operating the operation unit 53 of the rewrite detecting device 5.

Upon receiving the instruction to start the fraudulent rewrite detection processing from the operation unit 53, the rewrite detecting device 5 starts communication with the ECU 2 of the vehicle 1 through the wired communication unit 55. In the present embodiment, the rewrite detecting device 5 appropriately selects one of a plurality of ECUs 2 mounted in the vehicle 1, and performs the fraudulent rewrite detection processing on the program and data stored in the storage unit 22 of the selected ECU 2. After finishing the detection processing for one ECU 2, the rewrite detecting device 5 performs the detection processing on the ECU 2 which does not undergo the process. The rewrite detecting device 5 sequentially performs the detection processing on a plurality of ECUs 2 by repeating the processing, and thus performs the fraudulent rewrite detection processing on all the ECUs 2 serving as the detection target mounted in the vehicle 1.

The rewrite detecting device 5 may be configured to perform the fraudulent rewrite detection processing on a plurality of ECUs 2 connected to the in-vehicle network 3 collectively. However, in the present embodiment, the rewrite detecting device 5 is assumed to sequentially perform the fraudulent rewrite detection process on a plurality of ECUs 2 as described above. For the sake of simple description, the following description will proceed with an example in which the rewrite detecting device 5 performs the fraudulent rewrite detection process on one ECU 2. It is desirable to repeatedly perform a similar process on a plurality of ECUs 2.

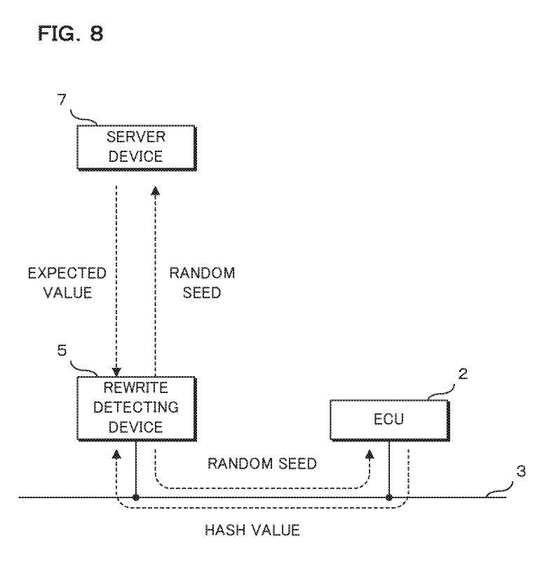

FIG. 8 is a schematic diagram for describing the rewrite detection processing performed by the rewrite detecting device 5. The rewrite detecting device 5 connected to the in-vehicle network 3 of the vehicle 1 gives a notification indicating that the rewrite detection processing starts on the ECU 2 serving as the rewrite detection processing target. In response to the notification, the ECU 2 of the target stops, for example, other processes, and performs preparation for the process of the hash value calculating unit 24 (however, other processes need not be necessarily stopped, and the hash value calculating unit 24 may be performed in parallel to other processes).

The rewrite detecting device 5 generates a random value based on an appropriate random number generation algorithm, and transmits the random value to the ECU 2 as the random seed. For example, a random value of 64 or more bits may be used as the random seed. When the hash value calculating unit 24 employs SHA-1 as the hash function, the random seed may have, for example, 160 bits. The ECU 2 that has received the random seed from the rewrite detecting device 5 performs a process of deciding a storage region serving as a hash value calculation processing target among the storage regions of the storage unit 22, and reads the storage details of the decided storage region. The ECU 2 calculates the hash value using a predetermined hash function based on the received random seed and the read storage details. The ECU 2 transmits the calculated hash value to the rewrite detecting device 5.

The rewrite detecting device 5 transmits the generated random seed to the server device 7, and transmits the inquiry about the expected value of the hash value for the random seed. At this time, the rewrite detecting device 5 decides the storage region of the storage unit 22 serving as the hash value calculation processing target using a method similar to that of the ECU 2. The rewrite detecting device 5 transmits vehicle information such as a vehicle ID (IDentifier) or a vehicle model of the vehicle 1 that is undergoing the rewrite detection processing, ECU identification information such as an ID identifying the ECU 2 serving as the processing target, and information designating the storage region serving as the hash value calculation processing target to the server device 7 together with the random seed.

The server device 7 that has received the above information refers to the rewrite detection database 75 of the storage unit 72. For example, when the rewrite detection database 75 has the configuration illustrated in FIG. 6, the server device 7 reads the storage details corresponding to the storage region designated by the inquiry from the storage details of the ECU 2 stored according to the vehicle model and the ECU type related to the inquiry transmitted from the rewrite detecting device 5. The server device 7 calculates the hash value based on the storage details read from the rewrite detection database 75 and the random seed related to the inquiry transmitted from the rewrite detecting device 5, and transmits the calculated hash value to the rewrite detecting device 5 as the expected value.

The rewrite detecting device 5 compares the hash value received from the ECU 2 with the expected value received from the server device 7. When the hash value and the expected value are identical to each other, the rewrite detecting device 5 determines that the fraudulent rewrite has not been performed on the program and data stored in the storage unit 22 of the ECU 2. On the other hand, when the hash value and the expected value are not identical to each other, the rewrite detecting device 5 determines that the fraudulent rewrite has been performed on the program and data of the ECU 2. The rewrite detecting device 5 causes information indicating whether or not the fraudulent rewrite has been performed to be displayed on the display unit 54 as a processing result of the rewrite detection processing.

The rewrite detecting device 5 may measure a period of time taken until the hash value is received after the random seed is transmitted to the ECU 2 and check the presence or absence of the rewrite based on the measured period of time. In this case, the rewrite detecting device 5 determines whether or not the measured period of time exceeds a threshold, and determines that the fraudulent rewrite has been performed on the program and data of the ECU 2 when the measured period of time exceeds the threshold. The threshold used for the determination is decided in advance in view of a communication rate between the rewrite detecting device 5 and the ECU 2, a processing capability of the ECU 2, and the like when the present system is designed.

<Storage Region Decision Method>

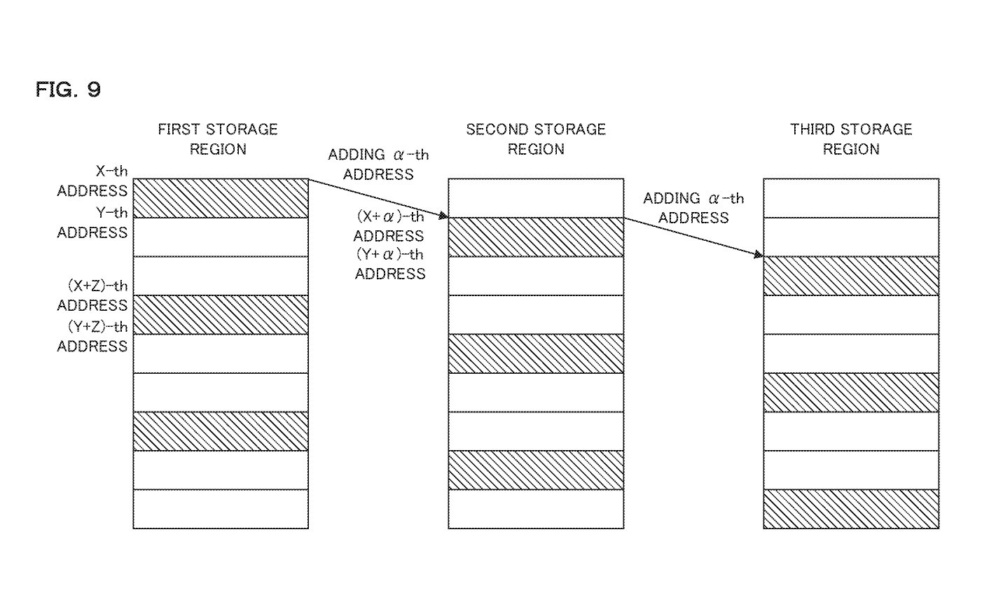

The hash value calculating unit 24 of the ECU 2 performs the process of deciding the storage region of the storage unit 22 serving as the calculation processing target when the hash value is calculated according to the random seed transmitted from the rewrite detecting device 5. FIG. 9 is a schematic diagram for describing a storage region decision method of the ECU 2 according to the first embodiment. A method of deciding the storage region through the hash value calculating unit 24, when a first hash value (an initial hash value) is calculated is different from that when a second or later hash value is calculated. In the present embodiment, a first storage region serving as the hash value calculation target is decided by the rewrite detecting device 5, and a notification indicating the first storage region is given to the ECU 2. When the hash value is initially calculated (for example, when information related to a previous hash value calculation is not stored), the hash value calculating unit 24 of the ECU 2 receives the information designating the storage region serving as the hash value calculation processing target from the rewrite detecting device 5 together with the random seed, and sets the designated storage region as the hash value calculation processing target. In FIG. 9, the rewrite detecting device 5 designates a plurality of non-consecutive regions, for example, storage regions ranging “from an X-th address to a Y-th address at intervals of Z-th addresses” as the first storage region. Thus, the hash value calculating unit 24 of the ECU 2 designates the X-th address to the Y-th address, an (X+Z)-th address to a (Y+Z)-th address, an (X+2Z)-th address to a (Y+2Z)-th address, and the like of the storage unit 22 as the storage region of the hash value calculation processing target. The values of X, Y, and Z may be values which are decided in advance or may be values which are randomly decided by the rewrite detecting device 5 each time. The hash value calculating unit 24 of the ECU 2 calculates the hash value based on the storage details of the designated storage region and the received random seed, and stores information related to the storage region used for the hash value calculation (the values of X, Y, and Z in this example).

The hash value calculating unit 24 of the ECU 2 can determine whether a current process is a first process (an initial process) or a second or later process according to whether or not the information related to the storage region used for the previous hash value calculation is stored. When the hash value calculating unit 24 calculates a second or larter hash value, the hash value calculating unit 24 decides a storage region to be used for a current hash value calculation process based on the storage region used for the previous hash value calculation. The hash value calculating unit 24 stores a predetermined value a which is used for decision of the storage region in advance. The hash value calculating unit 24 sets an address obtained by adding an α-th address to the address indicating the preivous storage region as the storage region of the current hash value calculation processing target. In the example illustrated in FIG. 9, the hash value calculating unit 24 designates (X+α) to (Y+α), (X+α+Z) to (Y+α+Z), (X+α+2Z) to (Y+α+2Z), and the like of the storage unit 22 as the storage region of the second hash value calculation processing target. The hash value calculating unit 24 stores information related to the second storage region, and similarly designates (X+2α) to (Y+2α), (X+2α+Z) to (Y+2α+Z), (X+2α+2Z) to (Y+2α+2Z), and the like of the storage unit 22 as the storage region of the third hash value calculation processing target.

Since the inquiry about the expected value of the second hash value which is calculated is transmitted to the server device 7, the rewrite detecting device 5 needs to be aware of a storage region which the second or later hash value is calculated based on. To this end, the rewrite detecting device 5 stores the predetermined value a of the ECU 2 and the number of hash value calculations that have been performed on the ECU 2. The predetermined value a may be stored in, for example, the rewrite detecting device 5 in advance, may be acquired from, for example, the ECU 2 when the first hash value calculation is performed, or may be decided by, for example, the rewrite detecting device 5 and transmitted to the ECU 2 together with first storage region designation information. The rewrite detecting device 5 specifies the storage region serving as the current hash value calculation processing target based on the stored predetermined value a and the number of hash value calculations and makes the inquiry about the expected value by transmitting information indicating the storage region, the random seed, and the like to the server device 7.

<Flowcharts>

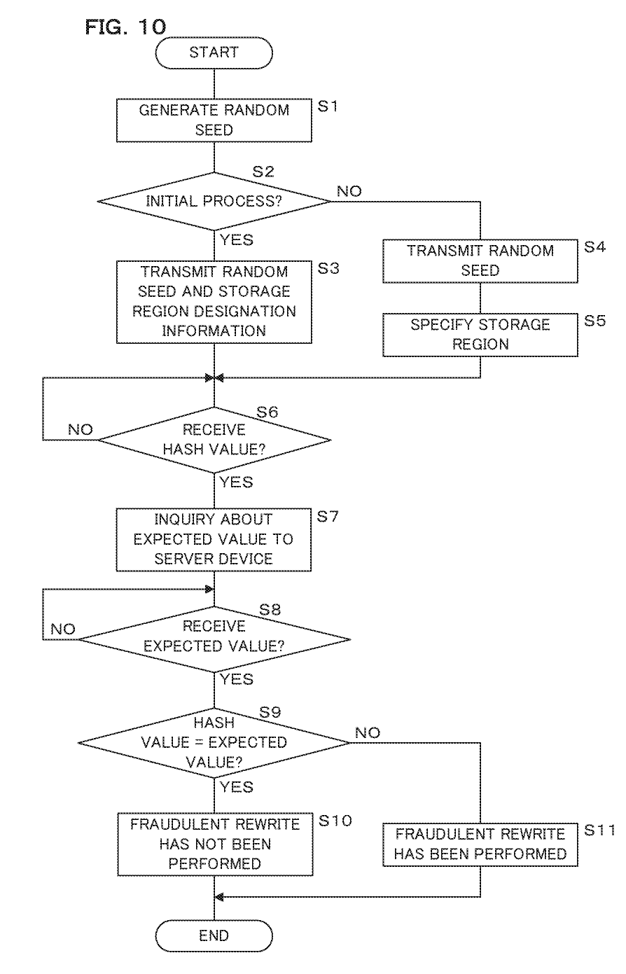

Next, the rewrite detection processing performed by the rewrite detection system according to the present embodiment will be described using flowcharts. In this description, the rewrite detection database is assumed to employ the configuration illustrated in FIG. 6. FIG. 10 is a flowchart illustrating a procedure of a rewrite detection processing performed by the rewrite detecting device 5. The processing unit 51 of the rewrite detecting device 5 generates the random seed based on a random number generation algorithm (step S1). The processing unit 51 determines whether or not the hash value calculation process performed by the ECU 2 to which the random seed is transmitted is an initial process (step S2). When the hash value calculation process performed by the ECU 2 is the initial process (YES in S2), the processing unit 51 transmits information designating the storage region serving as the hash value calculation processing target to the ECU 2 together with the random seed generated in step S1 through the wired communication unit 55 (step S3), and causes the process to proceed to step S6.

When the current hash value calculation process is not the initial process but the second or larter process (NO in S2), the processing unit 51 transmits the random seed generated in step Si to the ECU 2 of the target (step S4). Further, the processing unit 51 acquires the stored predetermined value a and the number of hash value calculation processes that have been performed in connection with the ECU 2, specifies the storage region of the storage unit 22 of the ECU 2 serving as the current hash value calculation processing target based on the predetermined value a and the number of hash value calculation processes (step S5), and causes the process to proceed to step S6.

The processing unit 51 determines whether or not the hash value transmitted from the ECU 2 serving as the processing target in response to the random seed is received through the wired communication unit 55 (step S6), and when the hash value is not received (NO in S6), the processing unit 51 is on standby until the hash value is received. When the hash value is received (YES in S6), the processing unit 51 transmits the vehicle information, the identification information of the ECU 2, the random seed generated in step S1, and the storage region designated in step S3 or the storage region specified in step S5 to the server device 7, and makes the inquiry about the expected value of the hash value received from the ECU 2 (step S7). The processing unit 51 determines whether or not the expected value transmitted from the server device 7 in response to the inquiry is received (step S8), and when the expected value is not received (NO in S8), the processing unit 51 is on standby until the expected value is received.

When the expected value is received from the server device 7 (YES in S8), the processing unit 51 determines whether or not the hash value received in step S6 is identical to the expected value received in step S8 (step S9). When the hash value and the expected value are identical to each other (YES in S9), the processing unit 51 determines that the fraudulent rewrite has not been performed (step S10), gives a notification indicating that the fraudulent rewrite has not been performed to the display unit 54, and ends the process. When the hash value and the expected value are not identical to each other (NO in S9), the processing unit 51 determines that the fraudulent rewrite has been performed (step S11), gives a notification indicating that the fraudulent rewrite has been performed to the display unit 54, and ends the processing.

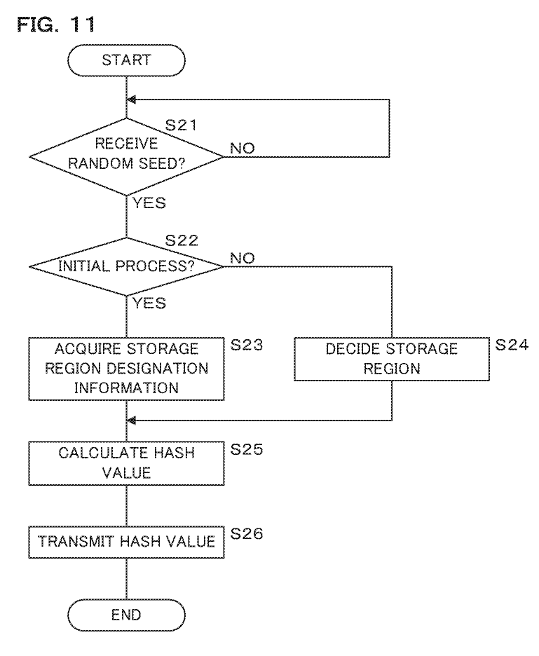

FIG. 11 is a flowchart illustrating a procedure of a rewrite detection processing performed by the ECU 2. The processing unit 21 of the ECU 2 determines whether or not the random seed transmitted from the rewrite detecting device 5 is received through the communication unit 23 (step S21), and when the random seed is not received (NO in S21), the processing unit 21 is on standby until the random seed is received. When the random seed is received (YES in S21), the hash value calculating unit 24 of the processing unit 21 determines whether or not the hash value calculation process is the initial process based on whether or not the information related to the previous hash value calculation process is stored (step S22). When the hash value calculation process is the initial process (YES in S22), the hash value calculating unit 24 acquires the storage region designation information transmitted from the rewrite detecting device 5 together with the random seed (step S23), and causes the process to proceed to step S25. When the hash value calculation process is not the initial process (NO in S22), the hash value calculating unit 24 decides the storage region serving as the current hash value calculation processing target based on the information related to the storage region used for the previous hash value calculation processing and the predetermined value a (step S24), and causes the process to proceed to step S25.

The hash value calculating unit 24 of the processing unit 21 calculates the hash value using a predetermined hash function based on the random seed received from the rewrite detecting device 5 and the storage details of the storage region designated by the information acquired in step S23 or the storage region decided in step S24 (step S25). The processing unit 21 transmits the hash value calculated by the hash value calculating unit 24 to the rewrite detecting device 5 through the communication unit 23 (step S26), and ends the processing.

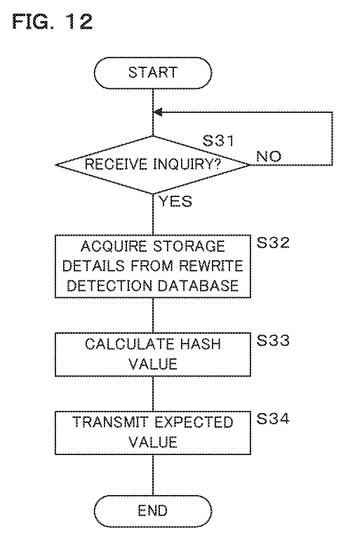

FIG. 12 is a flowchart illustrating a procedure of a rewrite detection processing performed by the server device 7. The processing unit 71 of the server device 7 determines whether or not the inquiry about the expected value is received from the rewrite detecting device 5 through the communication unit 73 (step S31), and when the inquiry about the expected value is not received (NO in S31), the processing unit 71 is on standby until the inquiry is received. When the inquiry about the expected value is received from the rewrite detecting device 5 (YES in S31), the processing unit 71 acquires the storage details of the designated storage region from the rewrite detection database 75 of the storage unit 72 based on the vehicle information, the ECU type information and the storage region designation information, and the like included in the inquiry (step S32). Then, the processing unit 71 calculates the hash value based on the random seed included in the inquiry transmitted from the rewrite detecting device 5 and the storage details acquired in step S32 (step S33). The processing unit 71 transmits the calculated hash value to the rewrite detecting device 5 as the expected value (step S34), and ends the processing.

<Conclusion>

In the rewrite detection system having the above configuration according to the first embodiment, the rewrite detecting device 5 generates the random seed and transmits the random seed to the ECU 2, and the ECU 2 calculates the hash value using a predetermined hash function based on the received random seed and the storage details (the program or data) of the storage unit 52, and transmits the calculated hash value to the rewrite detecting device 5. At this time, the ECU 2 decides the storage region serving as the hash value calculation processing target among the storage regions of the storage unit 22 by itself, and calculates the hash value. The rewrite detecting device 5 determines whether the hash value received from the ECU 2 is right or wrong, and determines whether or not the fraudulent rewrite has been performed on the program or data. In other words, the rewrite detecting device 5 can determine that the fraudulent rewrite has not been performed when the hash value is right and determine that the fraudulent rewrite has been performed when the hash value is not right.

Thus, the rewrite detecting device 5 can detect the fraudulent rewrite performed on the program or the data of the ECU 2 and appropriately take a countermeasure such as the operation stop, the repair, or the replacement of the ECU 2 that has undergone the fraudulent rewrite. In the second or later process, the ECU 2 decides the storage region serving as the hash value calculation processing target by itself, and the rewrite detecting device 5 need not transmit the information designating the storage region to the ECU 2, and thus the communication traffic between the rewrite detecting device 5 and the ECU 2 can be reduced. Further, the ECU 2 receives the random seed and thus can start the hash value calculation processing without waiting for reception of the information designating the storage region, and the processing time can be reduced.

The hash value calculating unit 24 of the ECU 2 designates the storage region which is apart from the storage region used as the previous hash value calculation target by a predetermined address value a as the storage region of the current processing target. The rewrite detecting device 5 also stores the same predetermined address value a, and specifies a storage region which is a calculation target for which the hash value is calculated by the ECU 2. Thus, the ECU 2 can decide the storage region serving as the hash value calculation processing target easily and reliably.

The rewrite detection by the rewrite detecting device 5 is performed periodically and repeatedly, for example, at the time of inspection of the vehicle 1. When the rewrite detection for the ECU 2 is initially performed, the rewrite detecting device 5 transmits the information designating the first storage region serving as the hash value calculation processing target to the ECU 2. When the information designating the storage region is received from the rewrite detecting device 5, the ECU 2 calculates the hash value using the designated storage region as the processing target, and otherwise, the ECU 2 calculates the hash value based on the predetermined address value a. Thus, when the hash value is initially calculated, the ECU 2 can detect the storage region serving as the processing target reliably and can calculate the hash value reliably.

Further, the server device 7 transmits the expected value in response to the inquiry transmitted from the rewrite detecting device 5, and the rewrite detecting device 5 performs the rewrite detection based on the expected value received from the server device 7 is identical to the hash value received from the ECU 2. For example, when the rewrite detecting device 5 is configured to store the expected value of the hash value, the expected value of the rewrite detecting device 5 is likely to be rewritten fraudulently, but since the rewrite detecting device 5 is configured to acquire the expected value from the server device 7, it is possible to prevent the fraudulent rewrite of the expected value.

The rewrite detecting device 5 is configured to be removably connected to the connector 4 of the in-vehicle network 3 of the vehicle 1 via the communication cable 6. The rewrite detecting device 5 can be installed in, for example, the dealer, the repair shot, or the like of the vehicle 1, and when the vehicle 1 undergoes the vehicle inspection, the regular inspection, the repair, or the like, the fraudulent rewrite detection on the program or the data of the ECU 2 can be performed. For example, in the case of the vehicle 1 such as a rental car or a shared car, the fraudulent rewrite detection can be performed through the rewrite detecting device 5 after the vehicle is returned.

In the present embodiment, the rewrite detecting device 5 is configured to transmit the information related to the storage region serving as the initial hash value calculation processing target to the ECU 2, but the present disclosure is not limited thereto. For example, in the initial hash value calculation processing, the ECU 2 may designate a predetermined region (a head region or the like) of the storage unit 22 as the processing target, and the rewrite detecting device 5 may not designate the storage region. Further, the rewrite detecting device 5 stores the predetermined address value a and the number of executed hash value calculation processes used for deciding the storage region and specifies the storage region of the current processing target based on the information, but the present disclosure is not limited thereto. For example, the ECU 2 may transmit information related to the storage region designated as the processing target to the rewrite detecting device 5 together with the calculated hash value.

Further, communication between the rewrite detecting device 5 and the vehicle 1 is performed through wired communication using the communication cable 6, but the present disclosure is not limited thereto, and communication between the rewrite detecting device 5 and the vehicle 1 may be performed through wireless communication using the wireless LAN or the like. The rewrite detecting device 5 is configured to perform communication with the server device 7 through the wireless communication unit 56, but the present disclosure is not limited thereto, and the rewrite detecting device 5 may be configured to perform communication with the server device 7 through wired communication. Further, the rewrite detecting device 5 is configured to be connected to the connector 4 of the in-vehicle network 3 of the vehicle 1, but the present disclosure is not limited thereto, and for example, the rewrite detecting device 5 may be connected to a device such as a gateway or the like installed in the vehicle 1, and the rewrite detecting device 5 may perform communication with the ECU 2 connected to the in-vehicle network through the gateway.

Further, the rewrite detecting device 5 is configured to acquire the hash value from the ECU 2 and then acquire the expected value from the server device 7, but the present disclosure is not limited thereto, and the rewrite detecting device 5 may acquire the expected value and then acquire the hash value or may acquire the hash value and the expected value in parallel. Further, the rewrite detecting device 5 is configured to sequentially perform the fraudulent rewrite detection on a plurality of ECUs 2 mounted in the vehicle 1 one by one, but the present disclosure is not limited thereto. For example, the rewrite detecting device 5 may collectively transmit the random seed to a plurality of ECUs 2 in a broadcast manner, acquire the hash value from a plurality of ECUs 2, and perform the rewrite detection process on a plurality of ECUs 2 simultaneously.

Further, the rewrite detection database 75 may be configured to be installed in the rewrite detecting device 5 rather than the server device 7. In other words, the rewrite detection system may not include the server device 7, and the rewrite detecting device 5 may be configured to store or calculate the expected value of the hash value. Further, the present embodiment has been described in connection with th example of the rewrite detection system in which the rewrite detection is performed on the program or the data of the ECU 2 mounted in the vehicle 1, but the present disclosure is not limited thereto, and for example, the rewrite detection may be performed on a program or data of an information processing device mounted in airplanes, ships, or other mobile objects.

The storage region illustrated in FIG. 9 is an example, and the present disclosure is not limited thereto. In the example illustrated in FIG. 9, a plurality of non-consecutive regions are designated as the first storage region, for example, “at intervals of Z-th addresses from the X-th address to the Y-th address,” but for example, a method of designating one consecutive region ranging from the “X-th address to the Y-th address” may be employed. Further, for example, a method of designating a plurality of head positions and a plurality of tail end positions such as “from an X1-th address to a Y1-th address, from an X2-th address to a Y2-th address, . . . , and from an Xn-th address to a Yn-th address” and designating a plurality of non-consecutive regions may be employed. In both of the cases, the ECU 2 can decide the storage region obtained by adding the predetermined address value a to the first storage region as the second storage region.

Further, the rewrite detecting device 5 may perform the acquisition of the hash value according to a part of the storage unit 22 of the ECU 2 once and perform the rewrite detection based on one the hash value. However, the rewrite detecting device 5 may transmit the random seed to the ECU 2 twice or more, acquire a plurality of hash values for a plurality of storage regions of the storage unit 22, and perform the rewrite detection based on a plurality of hash values. When the hash value acquisition is performed twice or more, the rewrite detecting device 5 can perform the rewrite detection more accurately. In this case, the rewrite detecting device 5 need not transmit the information designating the storage region at the time of second or larter hash value acquisition.

Further, the rewrite detecting device 5 is configured to generate the random seed, but the present disclosure is not limited thereto. For example, the server device 7 may be configured to generate the random seed. In this case, the rewrite detecting device 5 requests the server device 7 to transmit the random seed and the expected value. The server device 7 generates the random seed in response to the request, acquires or calculates a corresponding expected value with reference to the rewrite detection database 75, and transmits the random seed and the expected value to the rewrite detecting device 5. The rewrite detecting device 5 transmits the random seed received from the server device 7 to the ECU 2, receives the hash value calculated based on the random seed from the ECU 2, and detects the fraudulent rewrite by comparing the expected value transmitted from the server device 7 with the hash value transmitted from the ECU 2. Further, the server device 7 may be configured to generate the information designating the initial storage region as well.

Further, the rewrite detecting device 5 is configured to be removable connected to the in-vehicle network 3 of the vehicle 1, but the present disclosure is not limited thereto. For example, a device such as a gateway or a navigation device mounted in the vehicle 1 may be provided with the function of performing the rewrite detection process. Further, for example, one or more of a plurality of ECUs 2 mounted in the vehicle 1 may be provided with the function of performing the rewrite detection process.

### Second Embodiment

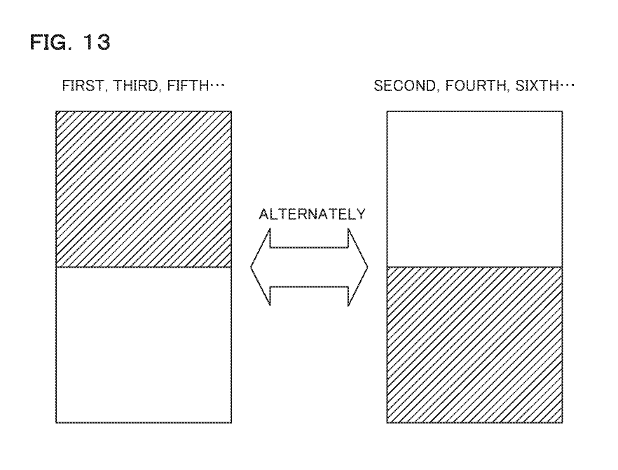

A rewrite detection system according to a second embodiment differs in a method of deciding the storage region serving as the hash value calculation processing target through the ECU 2. FIG. 13 is a schematic diagram for describing a storage region decision method of the ECU 2 according to the second embodiment. The ECU 2 according to the second embodiment divides the storage region of the storage unit 22 into two, that is, a first half portion and a second half portion and alternately designates the first half portion and the second half portion as the hash value calculation processing target. For example, when the random seed is initially received from the rewrite detecting device 5, the ECU 2 designates the first half portion of the storage unit 22 as the hash value calculation processing target. Then, when the random seed is received from the rewrite detecting device 5, the ECU 2 designates the second half portion of the storage unit 22 as the hash value calculation processing target. As described above, each time the random seed is received from the rewrite detecting device 5, the ECU 2 switches the hash value calculation processing target between the first half portion and the second half portion of the storage unit 22.

In the rewrite detection system according to the second embodiment, the rewrite detecting device 5 may select and designate one of the first half portion and the second half portion as the storage region serving as the initial hash value calculation processing target, or the initial half portion may be decided as the storage region serving as the initial hash value calculation processing target in advance, and the rewrite detecting device 5 may not designate it. In this configuration, the rewrite detecting device 5 need store the number of hash value calculations. The rewrite detection database 75 stored in the storage unit 72 in the server device 7 preferably has the configuration illustrated in FIG. 7.

In the rewrite detection system according to the second embodiment having the configuration, the ECU 2 divides the storage region of the storage unit 22 into two portions and alternately designates the two portions as the hash value calculation processing target, and thus it is possible to decide the storage region easily and reliably. In the present embodiment, the storage region of the storage unit 22 is divided into two, but the present disclosure is not limited thereto, the storage unit 22 may be divided into three or more, and the divided storage regions may be sequentially designated as the processing target.

Further, the remaining configuration of the rewrite detection system according to the second embodiment is similar to the configuration of the rewrite detection system of according to the first embodiment, the same parts are denoted by the same reference numerals, and thus a detailed description thereof is omitted.

### Third Embodiment

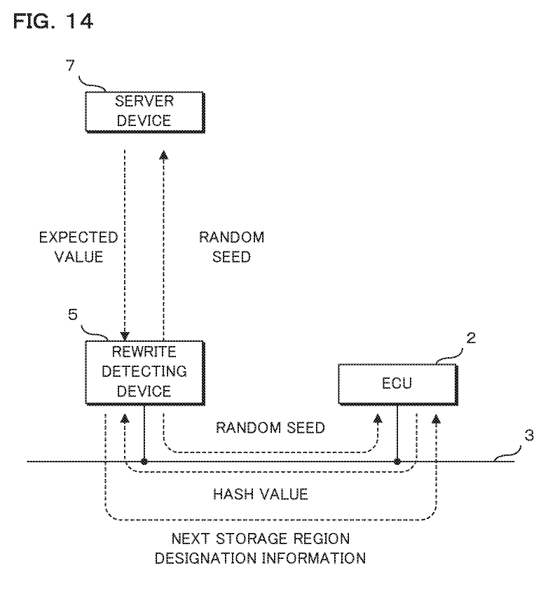

In the rewrite detection systems the first and second embodiments, the first (initial) storage region is designated by the rewrite detecting device 5, and the second or larter storage region is decided by the ECU 2. On the other hand, in a rewrite detection system according to a third embodiment, the rewrite detecting device 5 designates the storage region of the hash value calculation processing target each time. FIG. 14 is a schematic diagram for describing the rewrite detection system according to the third embodiment. A method of deciding the initial storage region in the rewrite detection system according to the third embodiment is similar to that in the rewrite detection system of according to the first embodiment. In other words, when the rewrite detection processing is initially performed on the ECU 2, the rewrite detecting device 5 according to the third embodiment transmits the information designating the storage region serving as the processing target to the ECU 2 together with the random seed. The ECU 2 calculates the hash value for the storage region designated by the information received together with the random seed, and transmits the calculated hash value to the rewrite detecting device 5.

The rewrite detecting device 5 that has received the hash value from the ECU 2 transmits the inquiry to the server device 7, acquires the expected value, and performs the rewrite detection for the ECU 2 by determining whether or not the hash value of the ECU 2 is identical to the expected value of the server device 7. After receiving the hash value from the ECU 2, for example, when, before, or after the expected value is acquired, the rewrite detecting device 5 according to the third embodiment decides the storage region which is designated as the next hash value calculation process by the ECU 2, and transmits the information designating the next storage region to the ECU 2. The ECU 2 that has received the next storage region designation information from the rewrite detecting device 5 stores the received information. The ECU 2 may store the next storage region designation information in a memory or the like (not illustrated in FIG. 2). Further, the ECU 2 may be configured to store the next storage region designation information in the storage unit 22, but in this case, it is necessary to exclude the storage region in which the next storage region designation information from the rewrite detection processing target.

In the second or later rewrite detection processing, the rewrite detecting device 5 according to the third embodiment generates the random seed, transmits the random seed to the ECU 2, and at this time, the information designating the storage region is not transmitted. The ECU 2 that has received the random seed transmitted from the rewrite detecting device 5 reads the storage region designation information stored in the previous processing, and designates the storage region designated by the read information as the hash value calculation processing target. The ECU 2 transmits the calculated hash value to the rewrite detecting device 5, and then receives and stores the next storage region designation information transmitted from the rewrite detecting device 5. The rewrite detecting device 5 also stores the next storage region designation information transmitted to the ECU 2 and uses the next storage region designation information for the inquiry to be transmitted to the server device 7 in the next processing.

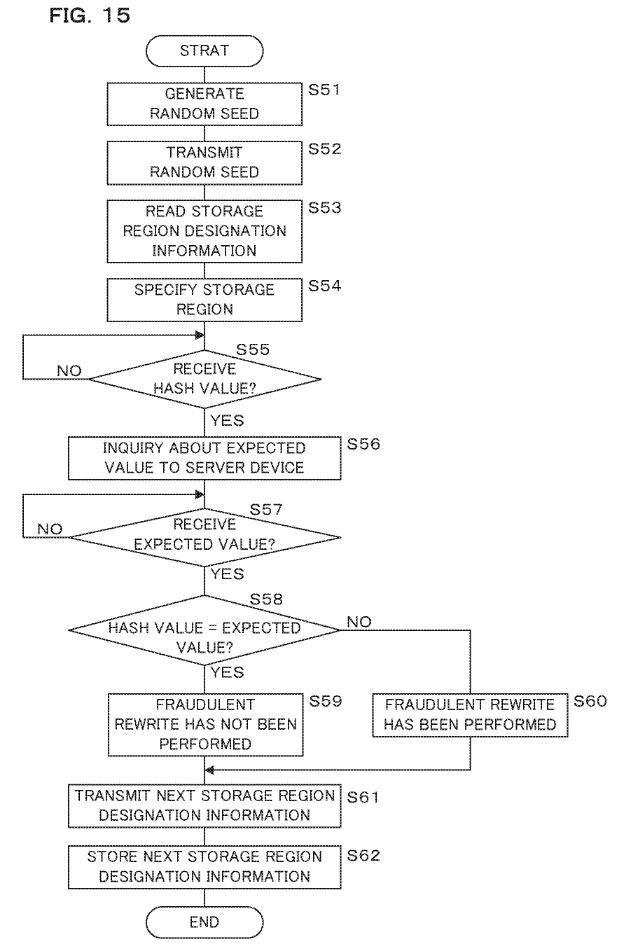

FIG. 15 is a flowchart illustrating a procedure of a rewrite detection processing performed by the rewrite detecting device 5 according to the third embodiment. In the present flowchart, a procedure of the first (initial) detection processing is omitted. The processing unit 51 of the rewrite detecting device 5 according to the third embodiment generates the random seed (step S51), and transmits the generated random seed to the ECU 2 of the target (step S52). Further, the processing unit 51 reads the storage region designation information stored in the previous rewrite detection processing (step S53), and specifies the storage region of the storage unit 22 of the ECU 2 serving as the current hash value calculation processing target based on the read information (step S54).

The processing unit 51 determines whether or not the hash value transmitted from the ECU 2 serving as the processing target is received through the wired communication unit 55 (step S55), and when the hash value is not received (NO in S55), the processing unit 51 is on standby until the hash value is received. When the hash value is received (YES in S55), the processing unit 51 transmits the inquiry about the expected value of the received hash value to the server device 7 (step S56). The processing unit 51 determines whether or not the expected value transmitted from the server device 7 in response the inquiry is received (step S57), and when the expected value is not received (NO in S57), the processing unit 51 is on standby until the expected value is received.

When the expected value is received from the server device 7 (YES in S57), the processing unit 51 determines whether or not the hash value received in step S55 is identical to the expected value received in step S57 (step S58). When the hash value and the expected value are identical to each other (YES in S58), the processing unit 51 determines that the fraudulent rewrite has not been performed (step S59), and causes the process to proceed to step S61. When the hash value and the expected value are not identical to each other (NO in S58), the processing unit 51 determines that the fraudulent rewrite has been performed (step S60), and causes the process to proceed to step S61.

Then, the processing unit 51 generates the information designating the storage region of the storage unit 22 of the ECU 2 which serves as the hash value calculation processing target in the next rewrite detection processing, and transmits the generated next storage region designation information to the ECU 2 (step S61). Further, the processing unit 51 stores the generated next storage region designation information in the storage unit 52 (step S62), and ends the rewrite detection processing.

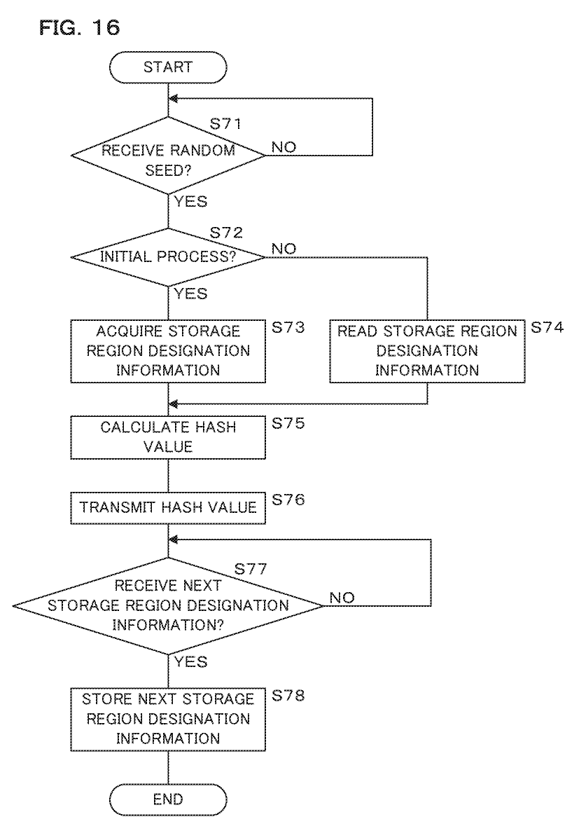

FIG. 16 is a flowchart illustrating a procedure of a rewrite detection processing performed by the ECU 2 according to the third embodiment. The processing unit 21 of the ECU 2 according to the third embodiment determines whether or not the random seed transmitted from the rewrite detecting device 5 is received through the communication unit 23 (step S71), and when the random seed is not received (NO in S71), the processing unit 21 is on standby until the random seed is received. When the random seed is received (YES in S71), the hash value calculating unit 24 of the processing unit 21 determines whether or not the hash value calculation process is the initial process based on whether or not the next storage region designation information received from the rewrite detecting device 5 in the previous rewrite detection process is stored (step S72). When the hash value calculation process is the initial process (YES in S72), the hash value calculating unit 24 acquires the storage region designation information transmitted from the rewrite detecting device 5 together with the random seed (step S73), and causes the process to proceed to step S75. When the hash value calculation process is not the initial process (NO in S72), the hash value calculating unit 24 reads the stored storage region designation information (step S74), and causes the process to proceed to step S75.

the hash value calculating unit 24 of the processing unit 21 calculates the hash value using a predetermined hash function based on the random seed received from the rewrite detecting device 5 and the storage details of the storage region designated by the information acquired in step S73 or the information read in step S74 (step S75). The processing unit 21 transmits the hash value calculated by the hash value calculating unit 24 to the rewrite detecting device 5 through the communication unit 23 (step S76).

Then, the processing unit 21 determines whether or not the next storage region designation information transmitted from the rewrite detecting device 5 that has received the hash value is received (step S77). When the next storage region designation information is not received (NO in S77), the processing unit 21 is on standby until the information is received. When the next storage region designation information is received (YES in S77), the processing unit 21 stores the received next storage region designation information (step S78), and ends the processing.

In the rewrite detection system according to the third embodiment having the above configuration, after receiving the hash value from the ECU 2, the rewrite detecting device 5 transmits the information designating the storage region serving as the next hash value calculation processing target to the ECU 2. The ECU 2 receives the storage region designation information from the rewrite detecting device 5 and stores the storage region designation information, and performs the calculation using the storage region designated in the stored storage region designation information as the processing target when the next hash value calculation is performed. In this configuration, it is necessary to transmit the information designating the storage region from the rewrite detecting device 5 to the ECU 2 each time, but the next storage region designation information may be transmitted at an arbitrary timing before the next detection processing is performed after the hash value is received from the ECU 2. Thus, the storage region designation information can be transmitted, for example, at a timing at which the network load is small. Further, when the random seed is received from the rewrite detecting device 5, the ECU 2 can detect the storage region of the processing target based on the stored storage region designation information and calculate the hash value without waiting for the reception of the information designating the storage region, and thus the processing time can be reduced.

Further, in the present embodiment, in the flowchart of FIG. 15, the rewrite detection is performed according to whether or not the hash value and the expected value are identical to each other, and then the next storage region designation information is transmitted from the rewrite detecting device 5 to the ECU 2, but the information transmission timing is not limited thereto. The rewrite detecting device 5 may transmit the next storage region designation information at any timing before the next rewrite detection processing starts after the current hash value is received from the ECU 2.

The remaining configuration of the rewrite detection system according to the third embodiment is similar to the configuration of the rewrite detection system of according to the first embodiment, the same parts are denoted by the same reference numerals, and thus a detailed description thereof is omitted.

It is to be noted that, as used herein and in the appended claims, the singular forms “a”, “an”, and “the” include plural referents unless the context clearly dictates otherwise.

It is to be noted that the disclosed embodiment is illustrative and not restrictive in all aspects. The scope of the present invention is defined by the appended claims rather than by the description preceding them, and all changes that fall within metes and bounds of the claims, or equivalence of such metes and bounds thereof are therefore intended to be embraced by the claims.

1-7. (canceled)

8. A rewrite detection system that detects rewrite of a program or data stored in a storage unit on an information processing device including the storage unit that stores the program or the data, a processing unit that performs processing based on the program or the data stored in the storage unit, and a communication unit that performs communication with another device via a network, the rewrite detection system comprising
a rewrite detecting device that includes a seed information transmitting unit that transmits seed information for hash value calculation to the information processing device via the network, a hash value receiving unit that receives a hash value transmitted from the information processing device in response to the seed information transmitted from the seed information transmitting unit, and a hash value determining unit that determines whether the hash value received through the hash value receiving unit is right or wrong, and detects the rewrite according to a determination result of the hash value determining unit,
wherein the information processing device includes a storage region deciding unit that decides a storage region to be used as a processing target in the storage unit and a hash value calculating unit that calculates the hash value based on the seed information transmitted by the seed information transmitting unit and the program or the data stored in the storage region decided by the storage region deciding unit and is configured to transmit the hash value calculated by the hash value calculating unit to the rewrite detecting device.

9. The rewrite detection system according to claim 8,
wherein the rewrite detecting device is configured to repeatedly transmit the seed information through the seed information transmitting unit and repeatedly detect the rewrite, and
the storage region deciding unit of the information processing device is configured to decide a storage region, which is apart from a storage region used as a processing target of previous hash value calculation by a predetermined address, as a processing target.

10. The rewrite detection system according to claim 8,
wherein the rewrite detecting device is configured to repeatedly transmit the seed information through the seed information transmitting unit and repeatedly detect the rewrite, and
the storage region deciding unit of the information processing device is configured to alternately decide first and second storage regions obtained by dividing the storage unit into two as the storage region of a processing target.

11. The rewrite detection system according to claim 8,
wherein the rewrite detecting device is configured to repeatedly transmit the seed information through the seed information transmitting unit and repeatedly detect the rewrite, and
the rewrite detecting device includes an information transmitting unit that transmits storage region designation information designating a storage region serving as a processing target of next hash value calculation to the information processing device after the hash value receiving unit receives the hash value from the information processing device,
the information processing device includes a storage region designation information storage processing unit that performs processing of storing the storage region designation information received from the rewrite detecting device, and
the storage region deciding unit of the information processing device is configured to decide the storage region based on the storage region designation information stored by the storage region designation information storage processing unit.

12. The rewrite detection system according to claim 9,
wherein the rewrite detecting device includes an information transmitting unit that transmits storage region designation information designating initial storage region to be used as a processing target of hash value calculation to the information processing device, and
the storage region deciding unit of the information processing device is configured to decide the initial storage region to be used as the processing target based on the storage region designation information received from the rewrite detecting device.

13. The rewrite detection system according to claim 10,
wherein the rewrite detecting device includes an information transmitting unit that transmits storage region designation information designating initial storage region to be used as a processing target of hash value calculation to the information processing device, and
the storage region deciding unit of the information processing device is configured to decide the initial storage region to be used as the processing target based on the storage region designation information received from the rewrite detecting device.

14. The rewrite detection system according to claim 11,
wherein the rewrite detecting device includes an information transmitting unit that transmits storage region designation information designating initial storage region to be used as a processing target of hash value calculation to the information processing device, and
the storage region deciding unit of the information processing device is configured to decide the initial storage region to be used as the processing target based on the storage region designation information received from the rewrite detecting device.

15. A rewrite detection system that detects rewrite of a program or data stored in a storage unit on an information processing device including the storage unit that stores the program or the data, a processing unit that performs processing based on the program or the data stored in the storage unit, and a communication unit that performs communication with another device via a network, the rewrite detection system comprising
a rewrite detecting device that includes a seed information transmitting unit that transmits seed information for a hash value calculation to the information processing device via the network, a hash value receiving unit that receives a hash value transmitted from the information processing device in response to the seed information transmitted from the seed information transmitting unit, a hash value determining unit that determines whether the hash value received through the hash value receiving unit is right or wrong, and an information transmitting unit that transmits storage region designation information designating a storage region serving as a processing target of next hash value calculation to the information processing device after the hash value receiving unit receives the hash value from the information processing device, and detects the rewrite according to a determination result of the hash value determining unit,
wherein the information processing device includes a storage region designation information storage processing unit that performs processing of storing the storage region designation information received from the rewrite detecting device and a hash value calculating unit that calculates the hash value based on the seed information transmitted by the seed information transmitting unit and the program or the data stored in the storage region designated in the storage region designation information stored by the storage region designation information storage processing unit, and is configured to transmit the calculated hash value to the rewrite detecting device.

16. An information processing device, comprising:
a storage unit that stores a program or data;
a processing unit that performs processing based on the program or the data stored in the storage unit;
a communication unit that performs communication with another device via a network;
a storage region deciding unit that decides a storage region to be used as a processing target from the storage unit; and
a hash value calculating unit that calculates the hash value based on the seed information transmitted from the other device and the program or the data stored in the storage region decided by the storage region deciding unit,
wherein the information processing device is configured to transmit the hash value calculated by the hash value calculating unit to the other device.
